(19) United States
(12) Patent Application Publication
(10) Pub. No.: US 2015/0139447 A1
(43) Pub. Date: May 21, 2015

(54) AUTOMATED CONSTRUCTION OF INFINITE IMPULSE RESPONSE FILTERS

(71) Applicant: Ian Greenhoe, Saint Petersburg, FL (US)

(72) Inventor: Ian Greenhoe, Saint Petersburg, FL (US)

(21) Appl. No.: 14/542,795

(22) Filed: Nov. 17, 2014

Related U.S. Application Data
(60) Provisional application No. 61/905,193, filed on Nov. 16, 2013.

(51) Int. Cl. H04R 3/04

(52) U.S. Cl. CPC H04R 3/04
USPC 381/98

(57) ABSTRACT

Systems and methods can support constructing an infinite impulse response (IIR) filter. A desired frequency response may be received. An initial filter model may be constructed comprising complimentary pairs of component IIR filters based upon the desired frequency response. The filter model may be converged according to stepwise refinement of individual terms within the filter model. A global error for the converged filter model may be computed. An additional complimentary pair of component IIR filters may be incorporated into the filter model in response to the global error exceeding a maximum acceptable error. In response to incorporation of additional component IIR filters, convergence and evaluation of the filter model may be iterated. Upon final convergence of the filter model, an aggregate IIR filter may be generated by combing the component IIR filters.

### RELATED APPLICATION

This application claims priority to U.S. Provisional Patent Application No. 61/905,193, filed Nov. 16, 2013 and entitled “Automated Construction of Infinite Impulse Response Filters.” The complete disclosure of the above-identified priority application is hereby fully incorporated herein by reference.

### BACKGROUND

A digital filter may operate on an input signal represented by a series of intensity-varying samples taken over time. The digital filter can transform the source into an output with desired properties. Coefficients of the digital filter may be chosen to emphasize or de-emphasize various frequency components of the filtered signal.

Determining the desired coefficients for a finite impulse response (FIR) filter can be straightforward. The trade-off for design simplicity is that a great deal of computation is generally needed to transform the input to the output. FIR filters typically require hundreds or thousands of multiplication operations, which are hard to streamline on most computational architectures.

In contrast, an infinite impulse response (IIR) filter may require much less computation to transform the input to the output. According to certain examples, an IIR filer may only require ten to twenty multiplications per output sample. This can be streamlined on most modern hardware, electronics, or computational platforms. Traditionally, a tradeoff is a very high level of difficulty in determining the desired coefficients for an IIR filter. IIR filter design may be quite challenging, often taking experts days to do the necessary computations. First, it is generally difficult to get the filter to exhibit the desired transformative properties. Second, the filter often exhibits significant phase distortion, which can make it difficult to continue working with the output. Last, the filter can easily diverge unless certain properties are strictly adhered to.

Traditionally, these problems are significant enough to make IIR filters unfeasible to automatically generate. Also, the filters so derived are limited in the number of coefficients they can utilize.

There is a need in the art for technology to automatically construct IIR filters that can substantially address all three of the issues listed above as well as other related limitations and challenges.

### SUMMARY

In certain example embodiments described herein, methods and systems can support constructing an infinite impulse response (IIR) filter. A desired frequency response may be received. An initial filter model may be constructed comprising complimentary pairs of component IIR filters based upon the desired frequency response. The filter model may be converged according to stepwise refinement of individual terms within the filter model. A global error for the converged filter model may be computed. An additional complimentary pair of component IIR filters may be incorporated into the filter model in response to the global error exceeding a maximum acceptable error. Upon incorporation of additional component IIR filters, convergence and evaluation of the filter model may be iterated. Upon final convergence of the filter model, an aggregate IIR filter may be generated by combing the component IIR filters.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an Infinite Impulse Response (IIR) filter construction system, in accordance with one or more embodiments presented herein.

FIG. 2 is a block flow diagram depicting a method for constructing an IIR filter, in accordance with one or more embodiments presented herein.

FIG. 3 is a block flow diagram depicting a method for converging a current filter model, in accordance with one or more embodiments presented herein.

FIG. 4 is a block flow diagram depicting a method for converging individual terms of a filter model, in accordance with one or more embodiments presented herein.

FIG. 5 is a block flow diagram depicting a method for converging a root pair in accordance with one or more embodiments presented herein.

FIG. 6 is a block diagram depicting a computing machine and a module in accordance with one or more embodiments presented herein.

### DETAILED DESCRIPTION OF EXAMPLE EMBODIMENTS

### Overview

The methods and systems described herein enable the automated, rapid construction of Infinite Impulse Response (IIR) filters. The resulting filters can provide filter outputs that conform very well to a specified desired filter response. The resulting filters can be quite stable, have controllable convergence time, and have minimal phase distortion. Furthermore, the resulting IIR filters may be adaptively and dynamically determined in response to changing parameters in an automated fashion without human intervention.

In addition to digital filters, analog electronic filters may be constructed from the resulting filter designs. The analog filter circuits can also be dynamically tuned with arbitrary frequency response curves. The circuits may be specified as to not require rectification thereby fitting a wide variety of applications including radio-frequency filters.

The functionality of various example embodiments will be explained in more detail in the following description to be read in conjunction with the figures illustrating system components and process flows. Turning now to the drawings, in which like numerals indicate like (but not necessarily identical) elements throughout the figures, example embodiments are described in detail.

### Example System Architectures

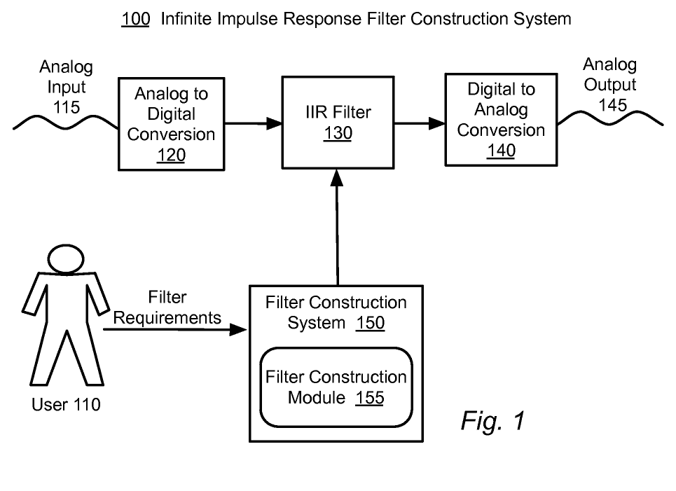

FIG. 1 is a block diagram depicting an Infinite Impulse Response (IIR) filter construction system 100, in accordance with certain exemplary embodiments. An analog to digital converter 120 may provide discretized samples of one or more analog input 115 signals to an IIR filter 130 for filtering according to the filter construction system 150. The output of the IIR filter 130 may be rendered to an analog output 145 signal by a digital to analog converter 140. The filter construction system 150 may execute in conjunction with one or more filter construction modules 155. The filter construction system 150 may design one or more IIR filters 130 according to filter requirements provided by a user 110.

The IIR filter 130 may operate upon one-dimensional signals, such as one or more streams of samples for audio or RF processing. The IIR filter 130 may operate upon higher dimensional signals, such as those for video, radar, sonar, medical imaging, document processing, geographical data, scientific data, or any other signals. While the IIR filter 130 is illustrated in use with an analog to digital converter 120 and a digital to analog converter 140, it should be appreciated that the IIR filter 130 may be used purely within the digital domain. For example, in image processing, machine vision, radar, and any number of other such applications. The IIR filter 130 may also be implemented using analog circuit components without analog to digital conversion 120 or digital to analog conversion 140. Such an analog circuit may be designed using the outputs from the filter construction system 150 any may be operable to operate directly upon an analog input 115 to generate an analog output 145.

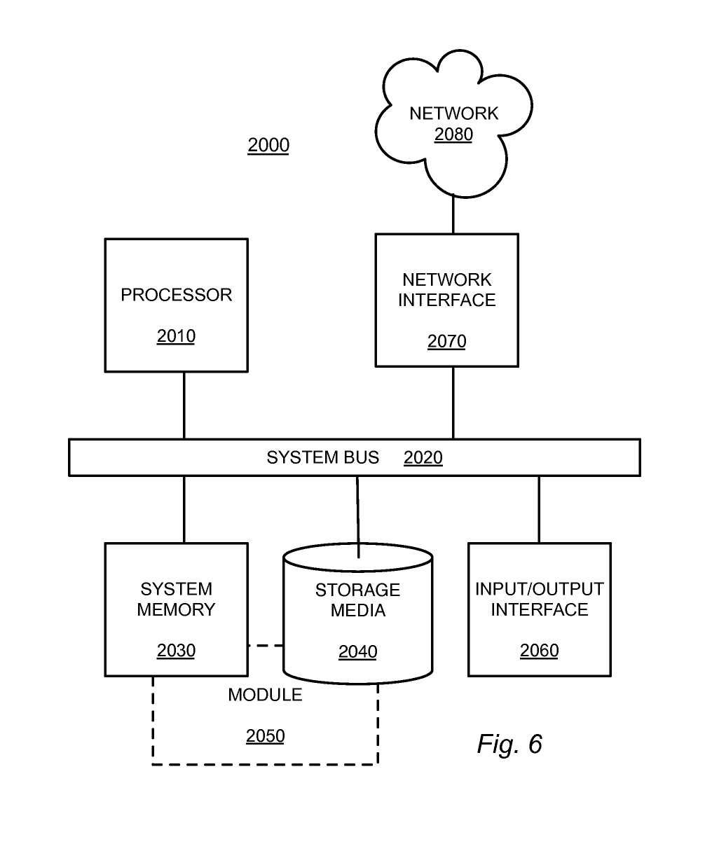

The IIR filter 130, and the filter construction system 150 may operate in conjunction with or execute upon any type of computing machine such as, but not limited to, those discussed in more detail with respect to FIG. 6. Any other computing machines associated with this technology may each be any type of computing machine such as, but not limited to, those discussed in more detail with respect to FIG. 6. Furthermore, the IIR filter 130, the filter construction module 155, and any modules associated with any of these computing machines or any other modules (scripts, web content, software, firmware, or hardware) associated with the technology presented herein may each be any of the modules discussed in more detail with respect to FIG. 6. The computing machines discussed herein may communicate with one another as well as other computer machines or communication systems over one or more networks such as any of the network technology discussed with respect to FIG. 6.

Digital filters, such as IIR filter 130, may operate on a specified input, which may be referred to as “source” or “S.” This input may be divided into a series of intensity-varying samples taken over time. Such sampling may be performed by analog to digital conversion 120. The digital filter can transform the source into an output with desired properties. These properties may be chosen to emphasize or de-emphasize the various frequency components of the source signal.

An example application of such a filter may be to reduce noise in a telephone call, such as reducing the “squeal” or “hiss” encountered when turning the audio into data to be sent from the person talking to the person listening. In such an example, the frequencies representing voice may be emphasized while extremely high frequencies and/or extremely low sounds frequencies may be de-emphasized.

A particular digital filter, such as IIR filter 130, may be understood in view of four separate series. The first two may be referred to as the “source” (“S”) and the “output” (“X”) and may be undetermined in length. The other two series may have a pre-defined number of samples that are specifically chosen for the desired properties of the filter. These may be referred to as the “feed-forward” (“A”) series and the “feedback” (“B”) series. It should be appreciated that when dealing with these series, the first element may be referred to using the index number zero and accordingly, the j^{th} element may be represented by the index (j−1). For example, the fourth output sample may be represented as X(3) where X(0) is considered to be the first output sample.

Filters, such as IIR filter 130, may be classified by how they respond to an “impulse” signal. In the digital domain, the impulse signal has the first sample equal to 1, and all following samples equal to 0. More compactly, S(j)=1 for j=0, and S(j)=0 for j≠0. Filters may be classified as being either Finite Impulse Response (FIR) filters or as Infinite Impulse Response (IIR) filters.

Finite Impulse Response (FIR) filters respond to the impulse signal for a limited number of samples. That is, after a certain point, all future output is equal to zero. An FIR filter is composed of a specific feed-forward series A. The FIR output X is computed by:

$$X ( n ) = A ( 0 ) S ( N ) + A ( 1 ) S ( n - 1 ) + … + A ( m ) S ( n - m ) = {\sum }_{j = 0}^{m} A ( j ) S ( n - j )$$

where A is the feed-forward series, and m is the lesser of n and the number of samples in A.

As the name implies, an Infinite Impulse Response (IIR) filter may, or may not, ever stop responding to the impulse signal. An IIR filter may be composed of a specific feed-forward series A as well as a specific feedback series B. In practice the feed-forward and feedback series are taken to be the same length. The IIR output X is computed by:

$$\begin{matrix}X ( n ) = A ( 0 ) S ( n ) + A ( 1 ) S ( n - 1 ) + … + A ( m ) S ( n - m ) + \\ B ( 1 ) X ( n - 1 ) + B ( 2 ) X ( n - 2 ) + … + B ( m ) X ( n - m ) \\ = {\sum }_{j = 0}^{m} A ( j ) S ( n - j ) + {\sum }_{j = 1}^{m} B ( j ) X ( n - j )\end{matrix}$$

where A is the feed-forward series, B is the feedback series, and m is the lesser of n and the number of samples in A and B.

The IIR filter 130 may be constructed in an automated fashion using a modular approach. The resulting IIR filter 130 can be designed to have a desired output response according to the filter requirements provided by the user 110. According to the design techniques presented herein, the resulting IIR filter 130 can be quite stable and robust. Also, the resulting IIR filter 130 can have controllable convergence times and minimal phase distortion.

The automation of the filter construction system 150 may operate by predicting how individual component filters behave when aggregated together to form the IIR filter 130. The behavior of the aggregated filter may be readily computed, and can then be used in a process that successively optimizes the resulting IIR filter 130 to the desired behavior. Specifically, a constant term may be combined with any number of individual component filters to provide a desired response curve to a desired level of accuracy. The individual component filters may each be IIR filters serving as fundamental building blocks for modular aggregation to ultimately provide the designed IIR filter 130.

Each individual component IIR filter may be specified by four parameters. The first parameter may be the multiplier (represented as M) where M may be the multiplier for a given component IIR filter.

The second parameter may be slant (represented as L). L can indicate how much a given component IIR filter is weighted toward lower or higher frequencies.

The third parameter may be normalized frequency (represented as F). F can indicate the point of maximum response for a given component IIR filter. The frequency being “normalized” can imply that the frequency is given as a fraction of the sample rate.

The fourth parameter may be the peak (represented as P). P can represent the relative difference between minimal and maximal response of a given component IIR filter.

Application of these parameters can simplify computing the output. For example, a resulting individual component filter can have a maximal response at the frequency represented by F. The maximal response may be given by M times P, and the minimal response may generally be close to M/2.

There may be numerical limits and practical limits on the construction of each individual component IIR filter. One numerical limit may be that the peak (P) should be greater than or equal to one. If P is less than zero, it can change where the maximal response will occur. If P is between zero and one, the resulting individual component filter may not be stable. According to various practical examples, P may be taken to be in the range of 1.01 to 500. The former can approximate a constant term, and the latter may require as many as 1,500 samples, or more, to converge within one standard deviation of the expected result.

As a practical matter, the frequency of maximum response (F) should be between zero and 0.5 as higher and lower numbers may be mapped back on this range. Accordingly, frequencies outside of this range may be mathematically meaningless. It should be appreciated that a negative frequency may imply a mathematical artifact associated with generating a purely real output.

In many applications, setting the slant (L) to a value other than zero may be undesirable. A non-zero slant can increase the phase distortion of the resulting filter. However, when a non-zero slant (L) is used, it may be beneficial to be in the range of −0.5 to 0.5. Values outside of this range may be mapped back to that range.

These four initial filter parameters may be used to compute two additional parameters given as “m” and “r”. Specifically:

$$m ( M , L ) = M ( cos ( L 2 π ) + isin ( L 2 π ) )$$

$$r ( F , P ) = ( 1 - \frac{1}{P} ) ( cos ( F 2 π ) + isin ( F 2 π ) )$$

where i is the imaginary number or the square root of negative one.

For each normalized frequency f in the range of 0 to 1, two terms called omega and omega-bar may be calculated as:

ω(f)=cos(f2π)+i sin(f2π)

ω̅(f)=cos(f2π)−i sin(f2π)

The theoretical frequency response associated with the component filter [symbol] (M,L,F,P) may be computed as:

$$resp \{ 𝒥 ( M , L , F , P ) , f \} = \frac{m ( M , L )}{1 - r ( F , P ) \overline{ω} ( f )}$$

The magnitude of this function may be the magnitude of the response of the filter. The rotation of the output of this function from the real axis may be the phase differential. Without the phase information, the combination of the resulting component IIR filters may become unpredictable.

Digital filters generally take a finite amount of time to converge to an output response. It can be predicted how long it will take for the actual filter response to converge to the theoretical response within a given degree of error. According to the parameters defined herein, an error rate for the n^{th} output sample versus the theoretical convergence may be specified by:

$$error \{ n , 𝒥 ( M , L , F , P ) \} = \frac{{M ( P - 1 )}^{n + 1}}{{P}^{n}}$$

The error equation can also be informed to take into account different rates of convergence based on frequency. The slowest rate of convergence may be associated with computing the Frequency (F) parameter of the filter.

An aggregate filter may be constructed from multiple individual component filters and a constant term. The resulting filter can have the theoretical frequency response of the sum of the constant term and the frequency response of all of the component filters. For example, an aggregate filter [symbol] _{aggregate} may be composed of a constant term C and the three individual component filters:

[symbol]

₁= [symbol] (M₁,L₁,F₁,P₁),

[symbol]

₂= [symbol] (M₂,L₂,F₂,P₂), and

[symbol]

₃= [symbol] (M₃,L₃,F₃,P₃)

Accordingly, [symbol] _{aggregate} can have the frequency response

resp{ [symbol] _{aggregate},f}=C+resp{ [symbol] ₁,f}+resp{ [symbol] ₂,f}+resp{ [symbol] ₃,f}

The upper bound on the error term may be given by

error{n, [symbol] _{aggregate}}≦error{n, [symbol] ₁}+error{n, [symbol] ₂}+error{n, [symbol] ₃}

Constructing an aggregate filter that provides output only in the real domain may have two requirements. First, the constant C should be real, with no complex part. Second, for each individual component filter [symbol] (M, L, F, P) making up a given aggregate filter, the corresponding filter [symbol] (M, −L, −F, P) should be included as well. These two corresponding individual component filters together may be referred to as a “root pair” or a “complimentary pairs” of component filters.

In order to obtain the terms of the B series (feedback coefficients) for the compound filter that is composed of a constant term C and n individual component filters

[symbol]

₁(M₁,L₁,F₁,P₁),

[symbol]

₂(M₂,L₂,F₂,P₂), . . .

[symbol]

ₙ(Mₙ,Lₙ,Fₙ,Pₙ)

The following polynomial may be constructed:

T_{B}(f)=(1−r(F₁,P₁) ω̅(f))(1−r(F₂,P₂) ω̅(f)) . . . (1−r(Fₙ,Pₙ) ω̅(f))

The values for the B series (feedback coefficients) can be determined from the polynomial T_{B} by taking the coefficient of the ω̅(f)^{j} term as the negative of B(j) for all non zero j. For example, B(2)=(−1) times the coefficient of ω̅(f)². B(0) may simply be set to zero despite the constant term of the polynomial being unity.

In order to obtain the terms of the A series (feed-forward coefficients) for the aggregate filter, a series of polynomials may be constructed. The first polynomial may be the polynomial T_{B} already defined. The remaining polynomials may be given by:

$${T}_{A , 1} ( f ) = ( 1 - r ( {F}_{2} , {P}_{2} ) \overline{ω} ( f ) ) ( 1 - r ( {F}_{3} , {P}_{3} ) \overline{ω} ( f ) ) … ( 1 - r ( {F}_{n} , {P}_{n} ) \overline{ω} ( f ) )$$

$${T}_{A , 2} ( f ) = ( 1 - r ( {F}_{1} , {P}_{1} ) \overline{ω} ( f ) ) ( 1 - r ( {F}_{3} , {P}_{3} ) \overline{ω} ( f ) ) … ( 1 - r ( {F}_{n - 1} , {P}_{n - 1} ) \overline{ω} ( f ) )$$

$$⋮$$

$${T}_{A , n} ( f ) = ( 1 - r ( {F}_{1} , {P}_{1} ) \overline{ω} ( f ) ) ( 1 - r ( {F}_{3} , {P}_{3} ) \overline{ω} ( f ) ) … ( 1 - r ( {F}_{n - 1} , {P}_{n - 1} ) \overline{ω} ( f ) )$$

In other words, the j^{th} polynomial includes all factors except for the j^{th} factor. These polynomials may be combined together according to:

T_{A}(f)=CT_{B}(f)+m(M₁,L₁)T_{A,1}(f)+m(M₂,L₂)T_{A,2}(f)+ . . . +m(Mₙ,Lₙ)T_{A,n}(f)

The values for the A series (feed-forward coefficients) can be determined from the T_{A} polynomial by taking the coefficient of the ω̅(f)^{j} term as A(j) for all j. For example, A(2) is the coefficient of ω̅(f)². A(0) may be taken as the constant term from the T_{A} polynomial.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

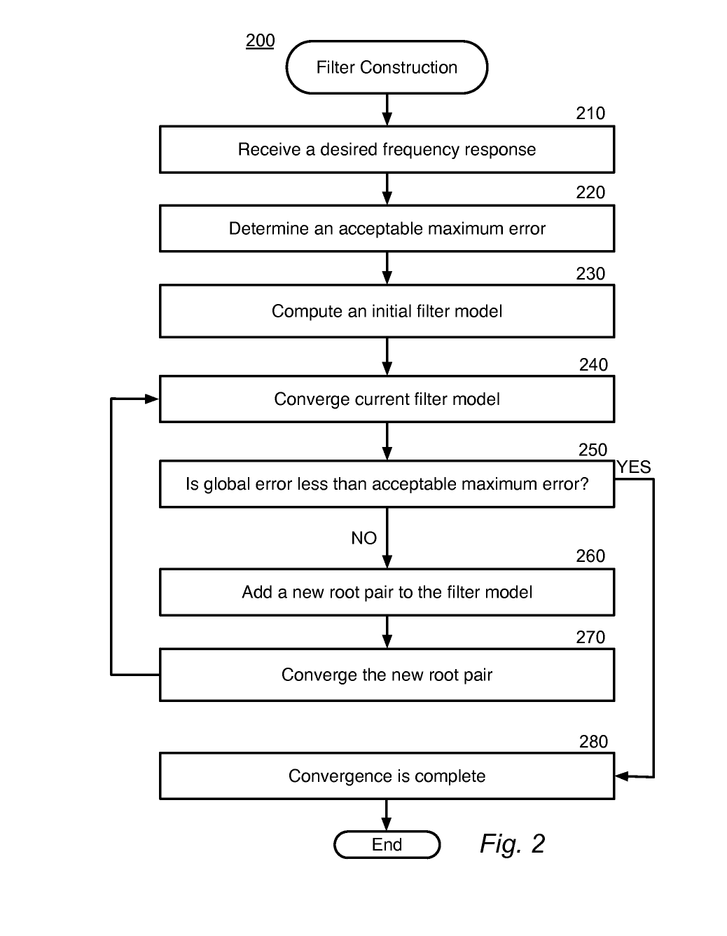

FIG. 2 is a block flow diagram depicting a method 200 for constructing the IIR filter 130, in accordance with certain exemplary embodiments. The process of creating the IIR filter 130 can involve a combination of several different convergence processes to establish the individual component filters that combine to provide the desired aggregate IIR filter. The convergence processes may be layered so as to minimize error between the performance of the IIR filter 130 and the desired output response.

In block 210, a desired frequency response curve is received. The user 110 may interact with a user interface associated with the filter construction system 150. The user 110 may provide the filter requirements, which may include the desired frequency response. Alternatively, the desired response curve may be adapted from, or received from, various sources. Examples of these sources may include, but are not limited to, sampling of sound from the environment, spectral analysis of noise, computational models, equalizer errors, linearizer feedback, and other direct and indirect methods of sampling or measuring real world signals or other signals.

The desired response curve may be referred to as dᵣ, or when referring to a specific normalized frequency fⱼ, the value may be expressed as dᵣ(fⱼ).

In certain example embodiments of desired filter response, certain guidelines may be applied. For example, the peak parameter may be limited to 500 for all root pairs, whereby the desired frequency response curve should be defined at approximately 1667 equidistantly spaced normalized frequencies. These can be given as fⱼ=0.0003 j, for 0≦j<1667. According to further examples, the frequency may be defined between zero and 0.5. According to further examples, the Peak parameter may be limited to 200, such that only 715 defined points may be needed. These may be specified as fⱼ=0.0007j, for 0≦j<715.

The desired frequency response curve should be reasonably smooth. Sharp “mountains” or “valleys” that total fewer than eight samples wide may result in poor, or failed, convergence. This limit may be invariant on the number of samples. However, if sharper feature recognition is desired, a higher limit for the Peak parameter may be used along with correspondingly more samples to ensure convergence. This correspondence between the number of samples required and the limit to the Peak filter parameter may be nearly linear. According to certain examples, a Peak limit of 1000 may correspond to approximately 3334 samples, and fⱼ may be given by fⱼ=0.00015j. The trade-off to a higher Peak limit may be a longer time to converge.

In block 220, an acceptable maximum error may be determined or established. This error can suggest how tightly the resultant filter response of the IIR filter 130 should conform to the desired filter response given by the filter requirements. The acceptable maximum error may be provided by the user 110 or established according to one or more design requirements for the resulting IIR filter 130.

In block 230, an initial filter model may be established. The initial filter model may be a simple connected line model of the desired frequency response curve. The line model may be used at the start the process or “seed” the response curve to speed up global convergence.

For each of the joins in the initial model line segments, a root pair [symbol] (M, 0, F, P) and [symbol] (M, 0, −F, P) may be created. According to certain embodiments, F may be the normalized frequency of the sample at the join, P may be be 100, and M may be equal to the difference between the join and the average of the desired response curve, divided by 100. The constant term C may be initially set to the average of the desired response curve.

In block 240, the current filter model may be converged. The model may be converged according to process 300 below.

In block 250, it can be evaluated if the global error is less than the acceptable maximum error. The acceptable maximum error was determined in block 220. The global error may be determined by computing the sum of the square of the difference between the values on the desired frequency response curve dᵣ and the actual output from the aggregate filter [symbol] _{aggregate} for all of the frequency points fⱼ. According to certain example embodiments, the global error would be given as:

$$E ( {d}_{r} , {𝒥}_{aggregate} ) = {\sum }_{j = 0}^{1667} {( {d}_{r} ( {f}_{j} ) - resp ( {𝒥}_{aggregate} , {f}_{j} ) )}^{2}$$

If the global error is less than the acceptable maximum error, process 200 can transition to block 280 where the convergence of the global, aggregate filter is complete. Otherwise, the process 200 can continue to block 260 where a new root pair may be added to the filter model.

In block 260, a new root pair may be added to the filter model. The point of maximum error may be identified as j where

(dᵣ(fⱼ)−resp( [symbol] _{aggregate},fⱼ))² is maximized.

The root pair [symbol] (M, 0, F, P) and [symbol] (M, 0, −F, P) may then be added to the model where F is fⱼ, P is 100, and M is given by:

$$\frac{{d}_{r} ( {f}_{j} ) - resp ( {𝒥}_{aggregate} , {f}_{j} )}{100}$$

In block 270, the new root pair [symbol] ⱼ(Mⱼ, 0, Fⱼ, Pⱼ) and [symbol] ⱼ(Mⱼ, 0, −Fⱼ, Pⱼ) may be converged according to process 500 below.

After block 270 completes converging the new root pair, process 200 can repeat back to step 240 to converge the current global aggregate filter model.

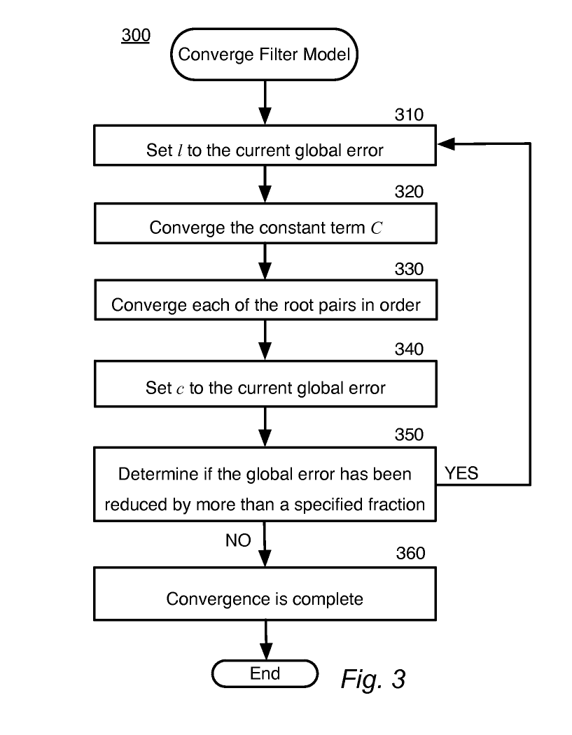

FIG. 3 is a block flow diagram depicting a method 300 for converging a current filter model, in accordance with certain exemplary embodiments.

In block 310, the variable l may be set to the current global error.

In block 320, the constant term C may be converged according to process 400 below.

In block 330, the various root pairs [symbol] ₁, [symbol] ₂, . . . , [symbol] ₙ may be converged in order. The root pairs may be converged according to the process 500 below.

In block 340, the variable c may be set to the current global error.

In block 350, it can be determined if the new global error c has been reduced by more than a specified fraction. For certain examples, it can be evaluated if 1.001 times c is less than l. It should be appreciated that the reduction factor of 1.001 is merely an example and other factors may be selected as appropriate. It should also be appreciated that while this convergence metric is applied as a fraction of reduction, other convergence metrics may be applied additively, or according to other mathematical relationships as appropriate. If the global error has been reduced by at least the specified amount, then the process 300 may be repeated back to the first step at block 310. Otherwise, if the global error reduction is converging to a smaller step reduction, the process 300 can continue to block 360 where the convergence of the current filter model filter is complete.

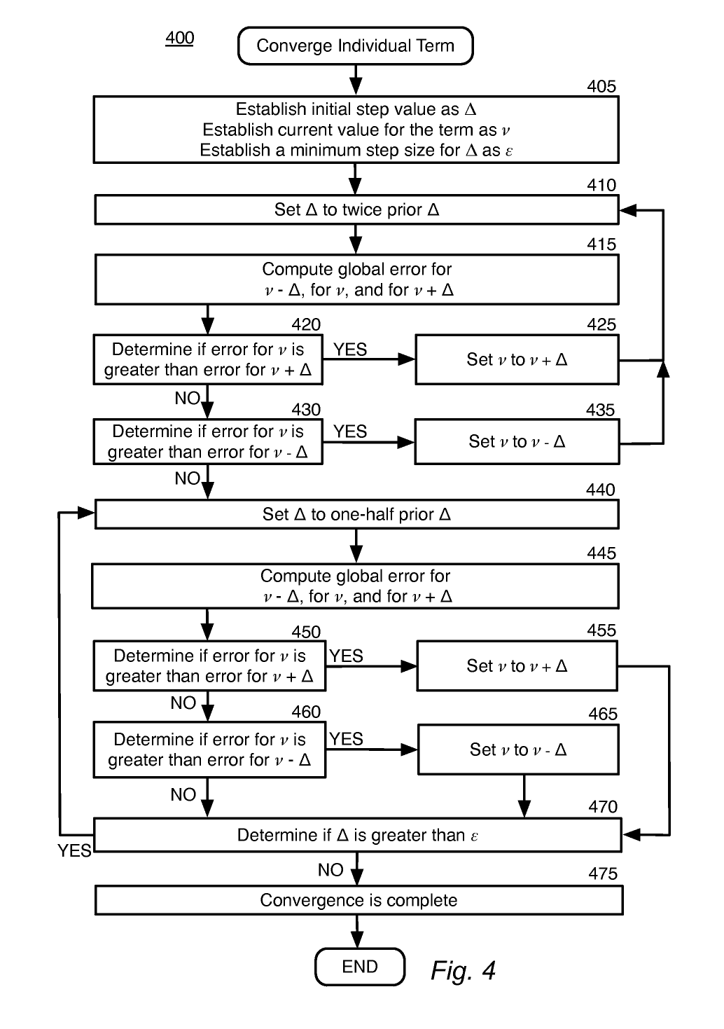

FIG. 4 is a block flow diagram depicting a method 400 for converging individual terms of a filter model, in accordance with certain exemplary embodiments.

In block 405, an initial step value Δ may be established. Also, a current value v for the term may be established. Also, a minimum step size for Δ, which may be referred to as ε, may be established.

In block 410, the step value Δ may be set to twice the prior step value.

In block 415, the global error for v−Δ (one step value less than the current term value) may be computed. Also, the global error for the term value v may be computed. Also, the global error for v+Δ (one step value greater than the current term value) may be computed.

In block 420, it may be determined if the error for v is greater than the error for v+Δ. If so, the process 400 may continue to block 425. Otherwise the process 400 may continue to block 430.

In block 425, the term value v may be increased by one step value (set to v+Δ). After block 425, the process 400 may repeat back to block 410.

In block 430, it may be determined if the error for v is greater than the error for v−Δ. If so, the process 400 may continue to block 435. Otherwise the process 400 may continue to block 440.

In block 435, the term value v may be decreased by one step value (set to v−Δ). After block 435, the process 400 may repeat back to block 410.

In block 440, the current step value Δ may be set to one-half of the prior step value.

In block 445, the global error for v−Δ (one step value less than the current term value) may be computed. Also, the global error for the term value v may be computed. Also, the global error for v+Δ (one step value greater than the current term value) may be computed.

In block 450, it may be determined if the error for v is greater than the error for v+Δ. If so, the process 400 may continue to block 455. Otherwise the process 400 may continue to block 460.

In block 455, the term value v may be increased by one step value (set to v+Δ). After block 455, the process 400 may skip ahead to block 470.

In block 460, it may be determined if the error for v is greater than the error for v−Δ. If so, the process 400 may continue to block 465. Otherwise the process 400 may continue to block 470.

In block 465, the term value v may be decreased by one step value (set to v−Δ). After block 465, the process 400 may continue to block 470.

In block 470, it may be determined if the step value Δ is greater than the minimum step size ε. If so, the process 400 may repeat back to block 440. Otherwise, the process 400 may continue to block 475.

In block 475, convergence for the individual term is complete.

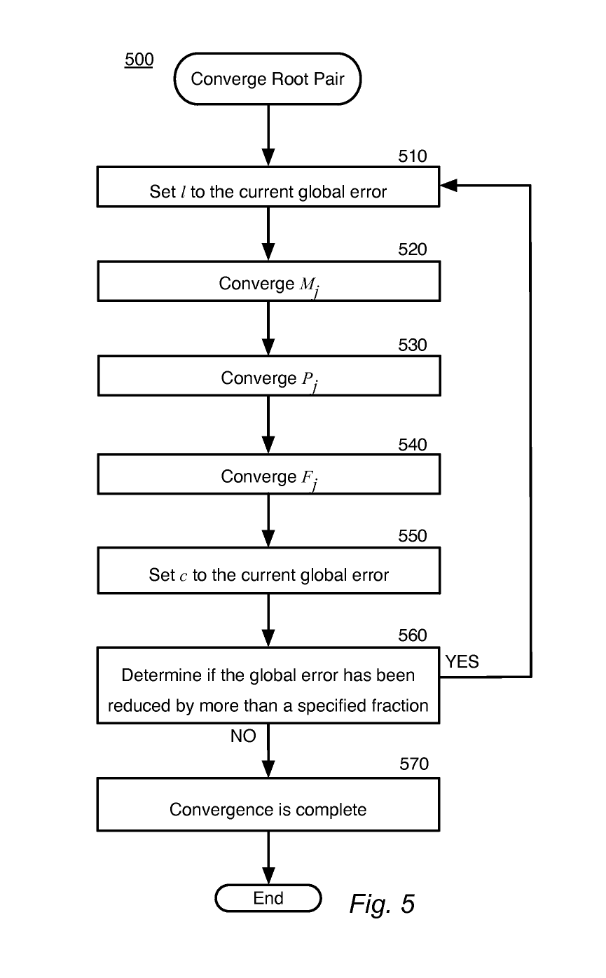

FIG. 5 is a block flow diagram depicting a method 500 for converging a root pair [symbol] ⱼ(Mⱼ, 0, Fⱼ, Pⱼ) and [symbol] ⱼ(Mⱼ, 0, −Fⱼ, Pⱼ) in accordance with certain exemplary embodiments.

In block 510, the variable l may be set to the current global error.

In block 520, the term Mⱼ may be converged according to the process 400.

In block 530, the term Pⱼ may be converged according to the process 400.

In block 540, the term Fⱼ may be converged according to the process 400.

In block 550, the variable c may be set to the current global error.

In block 560, it can be determined if the new global error c has been reduced by more than a specified fraction. For certain examples, it can be evaluated if 1.001 times c is less than l. It should be appreciated that the reduction factor of 1.001 is merely an example and other factors may be selected as appropriate. It should also be appreciated that while this convergence metric is applied as a fraction of reduction, other convergence metrics may be applied additively, or according to other mathematical relationships as appropriate. If the global error has been reduced by at least the specified amount, then the process 500 may be repeated back to the first step at block 510. Otherwise, if the global error reduction is converging to a smaller step reduction, the process 500 can continue to block 570 where the convergence of the root pair is complete.

### Example Systems

FIG. 6 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for constructing an infinite impulse response (IIR) filter, comprising:
receiving a desired frequency response;
constructing an initial filter model comprising complimentary pairs of component IIR filters based upon the desired frequency response;
converging the filter model according to stepwise refinement of individual terms within the filter model;
computing a global error for the converged filter model;
determining if the global error exceeds a maximum acceptable error;
incorporating an additional complimentary pair of component IIR filters into the filter model in response to the global error exceeding a maximum acceptable error;
iterating convergence and evaluation of the filter model in response to incorporating the additional complimentary pair of component IIR filters; and
generating an aggregate IIR filter by combing the component IIR filters from the converged filter model.

2. The computer-implemented method of claim 1, wherein incorporating the additional complimentary pair of component IIR filters comprises specifying the additional complimentary pair of component IIR filters according to a frequency of maximum error between the desired frequency response and the current filter model.

3. The computer-implemented method of claim 1, wherein constructing an initial filter model comprises forming a model of the desired frequency response curve comprising connected line segments and specifying each of the complimentary pairs of component IIR filters according to the frequencies where the connected line segments join.

4. The computer-implemented method of claim 1, wherein parameters associated with the aggregate IIR filter specify filter tap coefficients of a digital IIR filter.

5. The computer-implemented method of claim 1, wherein parameters associated with the aggregate IIR filter specify circuit component values for an analog IIR filter.

6. The computer-implemented method of claim 1, wherein the aggregate IIR filter is implemented as part of a communication system.

7. The computer-implemented method of claim 1, wherein the aggregate IIR filter is implemented as part of a medical instrument.

8. The computer-implemented method of claim 1, wherein the aggregate IIR filter is implemented to correct the output of another filter.

9. The computer-implemented method of claim 1, wherein the aggregate IIR filter is used to initialize the state of an adaptive filter.

10. The computer-implemented method of claim 1, wherein the aggregate IIR filter is stable and has a purely real output.

11. An infinite impulse response (IIR) signal filtering system, comprising:
one or more processing units, and one or more processing modules, wherein the signal filtering system is configured by the one or more processing modules to:
receive a desired frequency response;
construct an initial filter model comprising complimentary pairs of component IIR filters based upon the desired frequency response;
converge the filter model according to stepwise refinement of individual terms within the filter model;
compute a global error for the converged filter model;
determine if the global error exceeds a maximum acceptable error;
incorporate an additional complimentary pair of component IIR filters into the filter model in response to the global error exceeding a maximum acceptable error;
iterate convergence and evaluation of the filter model in response to incorporating the additional complimentary pair of component IIR filters; and
generate an aggregate IIR filter by combing the component IIR filters from the converged filter model.

12. The signal filtering system of claim 11, wherein incorporating the additional complimentary pair of component IIR filters comprises specifying the additional complimentary pair of component IIR filters according to a frequency of maximum error between the desired frequency response and the current filter model.

13. The signal filtering system of claim 11, wherein constructing an initial filter model comprises forming a model of the desired frequency response curve comprising connected line segments and specifying each of the complimentary pairs of component IIR filters according to the frequencies where the connected line segments join.

14. The signal filtering system of claim 11, wherein parameters associated with the aggregate IIR filter specify filter tap coefficients of a digital IIR filter.

15. The signal filtering system of claim 11, wherein parameters associated with the aggregate IIR filter specify circuit component values for an analog IIR filter.

16. The signal filtering system of claim 11, wherein the aggregate IIR filter is implemented as part of a communication system.

17. The signal filtering system of claim 11, wherein the aggregate IIR filter is implemented as part of a medical instrument.

18. The signal filtering system of claim 11, wherein the aggregate IIR filter is implemented to correct for response curves associated with a microphone or a speaker.

19. The signal filtering system of claim 11, wherein the aggregate IIR filter is used to initialize the state of an adaptive filter.

20. A computer program product, comprising:
a non-transitory computer-readable storage medium having computer-readable program code embodied therein that, when executed by one or more computing devices, perform a method comprising:
receiving a desired frequency response;
forming a model of the desired frequency response curve comprising connected line segments and forming a filter model comprising complimentary pairs of component IIR filters by specifying each of the complimentary pairs of component IIR filters according to the frequencies where the connected line segments join;
converging the filter model according to stepwise refinement of individual terms within the filter model;
computing a global error for the converged filter model;
determining if the global error exceeds a maximum acceptable error;
incorporating an additional complimentary pair of component IIR filters into the filter model in response to the global error exceeding the maximum acceptable error, wherein the additional complimentary pair of component IIR filters are specified according to a frequency of maximum error between the desired frequency response and the current filter model;
iterating convergence and evaluation of the filter model in response to incorporating the additional complimentary pair of component IIR filters; and
generating an aggregate IIR filter by combing the component IIR filters from the converged filter model.
